(19) United States
(12) Patent Application Publication
(10) Pub. No.: US 2016/0034434 A1
(43) Pub. Date: Feb. 4, 2016

(54) CONTEXTUAL PAGE GENERATION WITH STRUCTURED CONTENT INDEPENDENT OF RESPONSIVE DISPLAY DEVICES

(71) Applicant: LearnZillion, Inc., Washington, DC (US)

(72) Inventors: Alix GUERRIER, Washington, DC (US); David POTSIADLO, Chesapeake, MD (US); Heather FINN, Arlington, VA (US)

(21) Appl. No.: 14/814,132

(22) Filed: Jul. 30, 2015

Related U.S. Application Data
(60) Provisional application No. 62/031,663, filed on Jul. 31, 2014.
(60) Provisional application No. 62/093,877, filed on Dec. 18, 2014.

(51) Int. Cl. G06F 17/22

(52) U.S. Cl. CPC G06F 17/2288; G06F 17/2247

(57) ABSTRACT

Methods and systems provide contextual page generation with structured content independent of responsive display devices. A request is first received from a user computing device for structured content. The request may include a user role, a presentation context, and a structured content identifier. Content items associated with the structured content identifier are then retrieved from a content database. One or more content items are selected from the retrieved content items based at least on the user role and the presentation context, and a page is constructed that includes the selected content items. Finally, the constructed page is transmitted to the user computing device for rendering and display. In one example, lesson plans prepared by an author are stored as structured content in the content database and contextual pages are generated from the structured content.

### CROSS REFERENCE TO RELATED APPLICATIONS

This application claims the benefit of U.S. Provisional Application No. 62/031,663, filed Jul. 31, 2014, and U.S. Provisional Application No. 62/093,877, filed Dec. 18, 2014, which are incorporated by reference in their entirety.

### BACKGROUND OF THE INVENTION

1. Field

Embodiments of the systems and methods described herein are generally related to accessing structured content over a network.

2. Background

Users increasingly want to access and interact with content over computer networks such as the Internet. Web services have been developed to support a variety of applications that involve content served over the Internet. Browsers that run on user devices allow users to navigate to websites and view web content served over the Web. Markup languages such as HTML are used to mark content according to a prescribed syntax that can be interpreted by browsers to facilitate display of the content on a user device. Semantic web programming is also being used to help computers better understand content for processing.

Web application developers, however, face a number of challenges to provide content. Users increasingly want to access content from different types of computing devices. These different types of devices often have different display resolutions or other characteristics.

Many web applications can serve content for a specified device type but this requires a web application to use a predetermined device type or to specify a device type for the content being served. For example, if the device is a mobile device with a limited medium to low resolution and smaller screen size than a desktop computer, the server may then construct a content page that is sized for display on the mobile device. Also, when a user navigates to a website of a web application, the content is served based on the user selections of content to be viewed within the web application. Different users will receive the same content regardless of their roles. This places a burden on an author of content to generate different documents or different versions of documents for different types of users.

Permissions are sometimes used to provide access to certain documents in a database for different users depending upon their roles. The burden on an author to create different types of documents or content for different types of users remains. For example, a web application may help a teacher create a lesson plan and then store the lesson plan for later retrieval and display. A teacher may also wish to create a student assessment and practice exercises for later retrieval by the teacher and by students. At present, a teacher would have to create different documents with different content and permissions stored at different addressable locations to accommodate what is appropriate for display to students and to teachers. To view content appropriate for their role as students, an existing web application would check their permissions as students and then serve the content allowed to be accessed, such as the student assessment and practical exercises from the permitted location. Likewise, for teachers accessing stored lesson plans, an existing web application would check their permissions as teachers and then serve the content allowed to be accessed from the permitted location.

Responsive page display techniques are becoming available on different display devices which can help a device that receives content from a web server size a page for display on the device. Such responsive page display techniques however fail to address problems of users with different roles and the burden on content authors.

What is needed are systems and methods that allow content to be intelligently provided to users of different device types without placing the burden on content authors to generate different versions of content for different roles and viewing modes.

### BRIEF SUMMARY OF THE INVENTION

The disclosure relates to creation and generation of content served to remote users over one or more computer networks. In embodiments, computer-implemented methods and systems provide contextual page generation with structured content independent of responsive display devices.

In an embodiment, a method for constructing contextual pages is provided. A request is first received from a user computing device for structured content. The request may include a user role, a presentation context, and a structured content identifier. Content items associated with the structured content identifier are then retrieved from a content database. One or more content items are selected from the retrieved content items based at least on the user role and the presentation context, and a page is constructed that includes the selected content items. Finally, the constructed page is transmitted to the user computing device for rendering and display.

In one example not intended to be limiting, lesson plans prepared by an author are stored as structured content in the content database. Contextual pages are generated from the structured content in response to a request based on whether a user is a teacher, student, parent, or other role and a view mode/presentation context. The presentation context may be selected by the user or determined from context of the request.

Further embodiments, features, and advantages of the present invention, as well as the structure and operation of the various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant arts based on the information contained herein.

### BRIEF DESCRIPTION OF THE DRAWINGS/FIGURES

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a diagram of an example system for contextual page generation, according to an embodiment.

FIG. 2 is a diagram of an example method for contextual page generation, according to an embodiment.

FIG. 3 is a table illustrating examples of user roles, device types, view modes/presentation contexts, content items, and content attributes, according to an embodiment.

FIG. 4 is a diagram illustrating example content of a lesson plan, according to an embodiment.

FIG. 5 is a flowchart illustrating an example method for structured content creation, according to an embodiment.

FIG. 6 is a flowchart illustrating an example method for creating and managing quick codes associated with structured content, according to an embodiment.

FIG. 7 is an example interface for initiating a request to create a quick code, according to an embodiment.

FIG. 8 is an example interface displaying a quick code for a lesson plan after a quick code is created, according to an embodiment.

FIG. 9 is an example interface for managing quick codes for assignments associated with a lesson plan, according to an embodiment.

FIG. 10 is an example interface displaying a lesson plan accessed by an unauthenticated user using a quick code, according to an embodiment.

FIG. 11 is an example interface displaying a lesson plan accessed using an assigned quick code, according to an embodiment.

FIG. 12 is an example interface for viewing assignment sessions associated with a particular user, according to an embodiment.

FIG. 13 is an example interface for viewing assignment sessions associated with a particular assigned quick code, according to an embodiment.

FIG. 14 is a diagram illustrating an example schema to represent quick code functionality in an educational environment, according to an embodiment.

FIG. 15 illustrates example markup for a contextual page representing a lesson plan generated for a teacher using a presentation view mode, according to an embodiment.

FIG. 16 illustrates example markup for a contextual page representing a lesson plan generated for a student using the presentation view mode, according to an embodiment.

FIG. 17 is a diagram illustrating an example computing device, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION OF THE INVENTION

Overview

The disclosure relates to content creation and generation served to remote users over one or more computer networks.

Computer-implemented methods and systems provide contextual page generation with structured content independent of responsive display devices. A contextual page constructor may receive from a user computing device a request including a user role and a view mode/presentation context. Content items associated with the structured content identifier may then be retrieved from a content database. One or more content items may be selected from the retrieved content items based at least on the user role and the presentation context, and a page may be constructed that includes the selected content items. Finally, the constructed page may be transmitted to the user computing device for rendering and display. In one example, lesson plans prepared by an author may be stored as structured content in the content database. Contextual pages may be generated from the structured content based on whether a user is a teacher, student, parent or other role and a selected view mode/presentation context. The presentation context may be selected by the user or determined from context of the request.

Contextual Page Generation from Structured Content

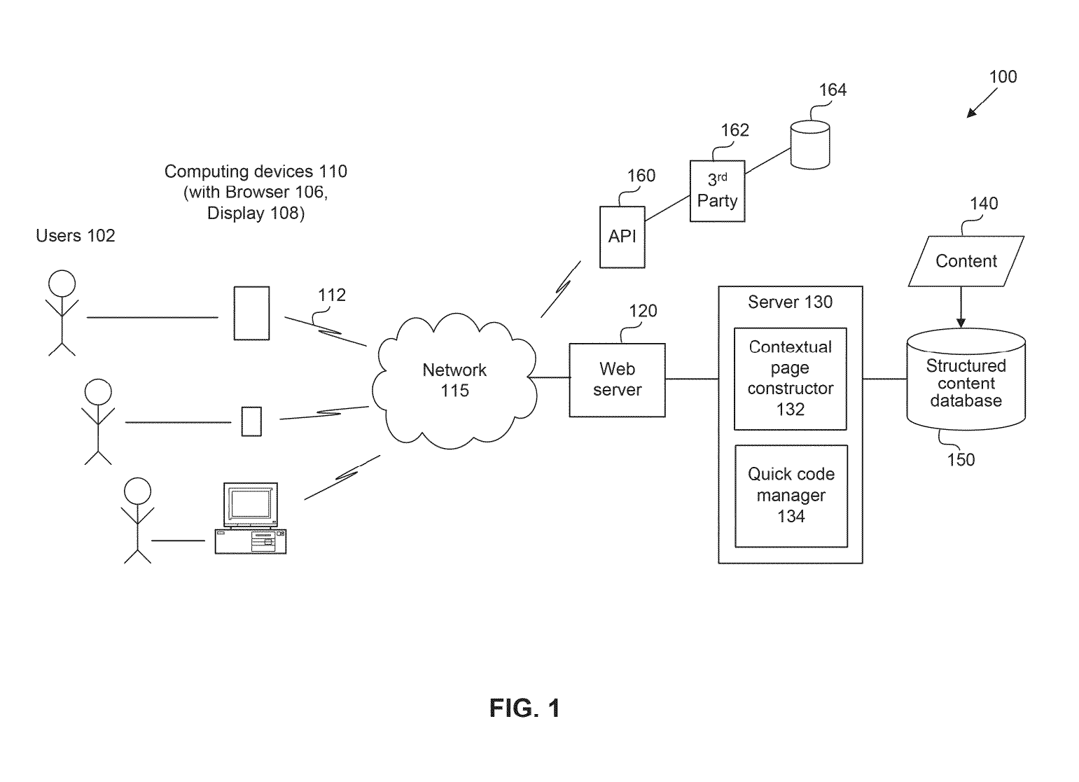

FIG. 1 is a diagram of an example system 100 for contextual page generation, according to an embodiment. System 100 includes one or more computing devices 110, network(s) 115, web server 120, server 130 including contextual page constructor 132, and structured content database 150.

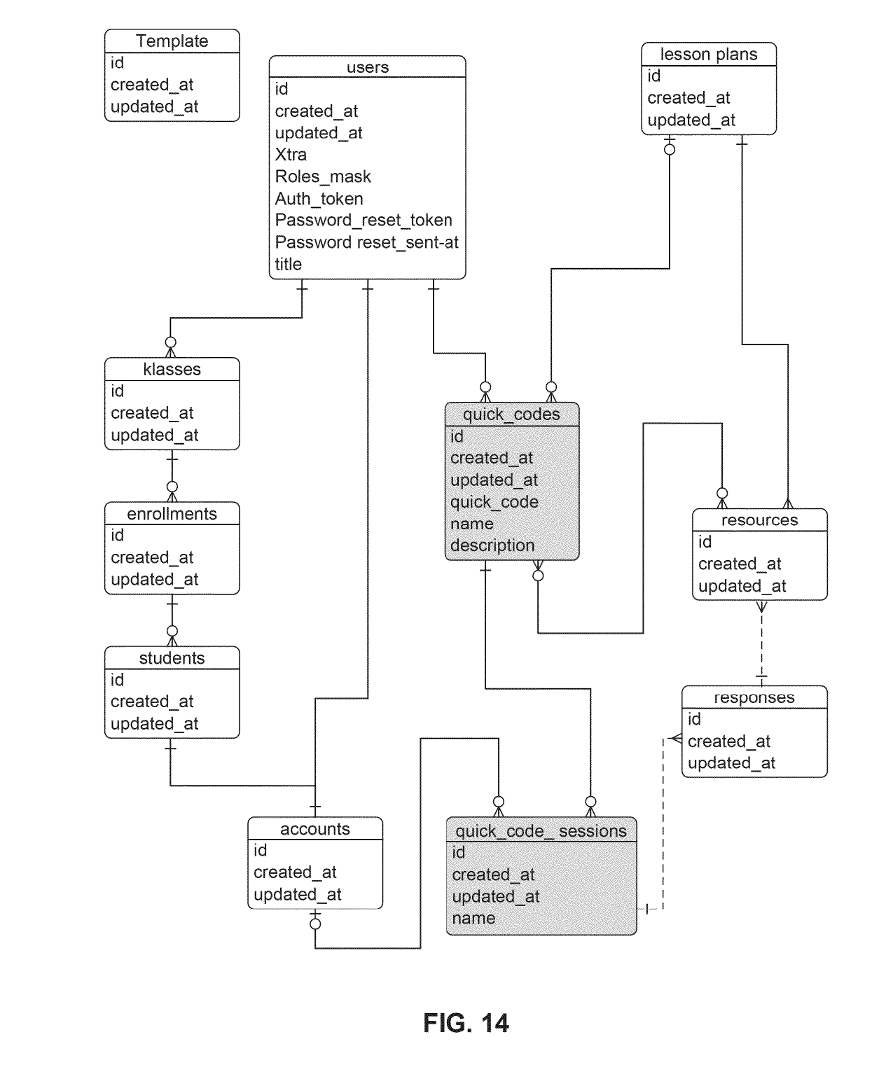

Users 102 may access computing devices 110. Computing devices 110 may be any type of computing device including but not limited to a computing device 1400 as described in FIG. 14. Computing devices 110 may be coupled to one or more networks 115 over respective communications links 112. Link 112 may be any type of communications link, including but not limited to, a wired or wireless link. Network(s) 115 may be any type of computer or telephony networks or combination of networks such as an intranet, local or medium area network, or a wide area network such as the Internet. In one example, computing device 110 may include a browser 106 and display 108 that allow a user 102 to browse and view pages served by web server 120. In a further feature, computing device may be a responsive display device.

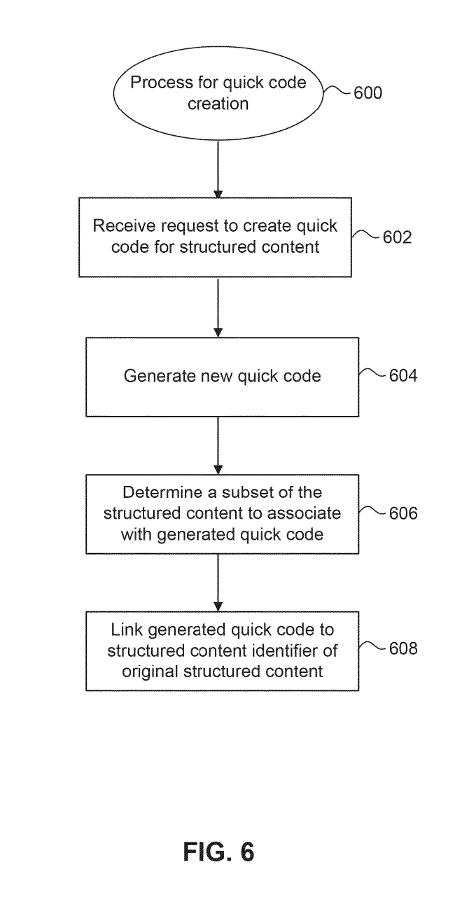

In an embodiment, server 130 includes contextual page constructor 132 and quick code manager 134, which is described further with respect to FIG. 6. Web server 120 may be part or separate from server 130. Structured content database 150 stores structured content 140 and is coupled to server 130. Web server 120, server 130, and database 150 may be located at the same or different locations and may be part of the same computing device, different computing devices, or distributed across a network. In an example embodiment, system 100 and its components, including web server 120, server 130, and structured content database 150, may include architecture distributed over one or more networks, such as, for example, a cloud computing architecture. Cloud computing includes but is not limited to distributed network architectures for providing, for example, software as a service (SaaS), infrastructure as a service (IaaS), platform as a service (PaaS), network as a service (NaaS), data as a service (DaaS), database as a service (DBaaS), backend as a service (BaaS), test environment as a service (TEaaS), API as a service (APIaaS), integration platform as a service (IPaaS), etc.

In operation, contextual page generator 132 may receive from a user computing device 110 a request for structured content. The request may include a user role, a view mode (also referred to as a presentation context), and a structured content identifier. Structured content may include any type of structured data able to be rendered for display to a user. Examples may include an educational lesson plan, a project tracking dashboard, or an investment trading platform interface. In an embodiment, the structured content identifier may identify particular structured content, such as a particular educational lesson plan. The structured content identifier may be a unique identifier and may be represented in any suitable form, for example a unique alphanumeric data field or combination of fields.

Contextual page generator 132 may retrieve content items associated with the structured content identifier from structured content database 150. In an embodiment, structured content 140 may be made up of content items. Contextual page generator 132 may then select one or more of the retrieved content items based at least on the user role and presentation context of the received request. In an embodiment, content items may also be selected based on the display resolution or screen size of the requesting device. For example, a mobile phone may have a low display resolution and/or small screen size, causing content items optimized for mobile devices to be selected. Finally, contextual page generator 132 may construct a page that includes the selected content items and send the constructed page to the user computing device 110 for rendering and display. In an embodiment, contextual page generator 132 may retrieve content items from structured content database 150 based at least on the user role and presentation context of the received request, rather than retrieving content items associated with a structured content identifier and then selecting content items from the retrieved content items.

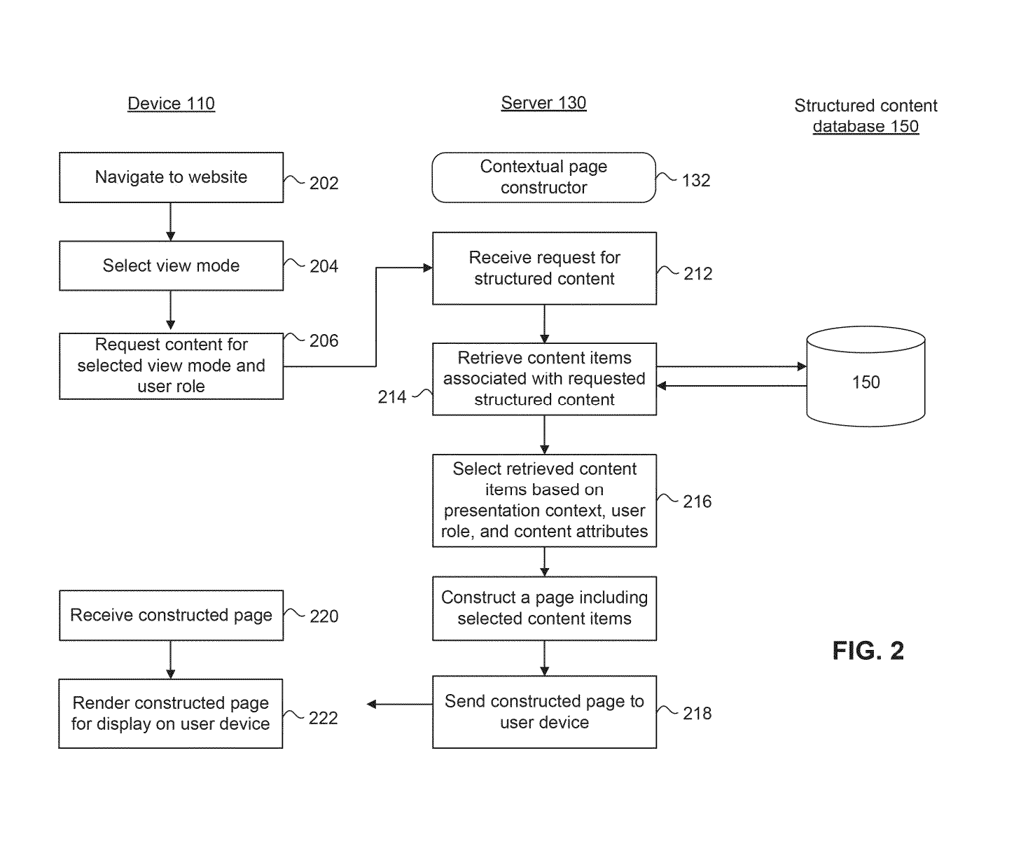

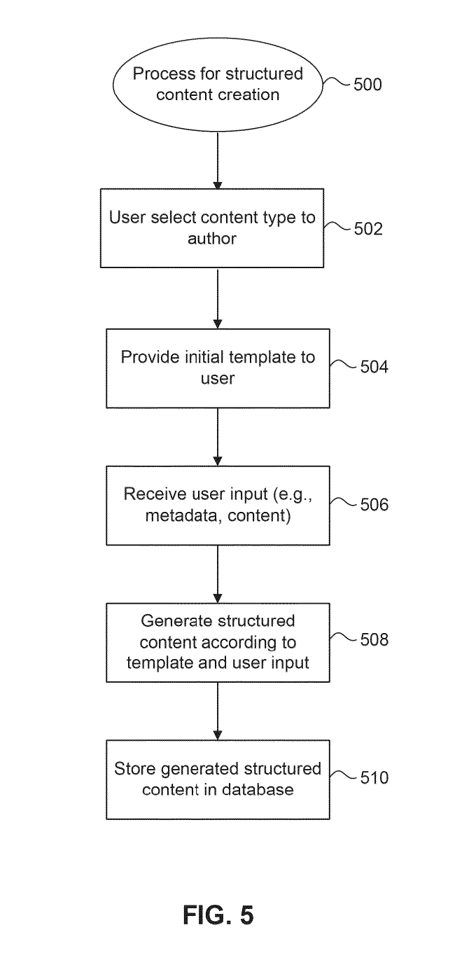

In a further embodiment, contextual page generator 132 may also retrieve content items provided by a third-party service 162 via an application programming interface 160. Third-party service 162 may be coupled to network 115 and database 164, which may store third-party content items. Further examples of the operation of system for contextual page generation 100 is described below with respect to FIGS. 2-4. Creation of structured content 140 is also described with respect to the routine of FIG. 5.

### Operation

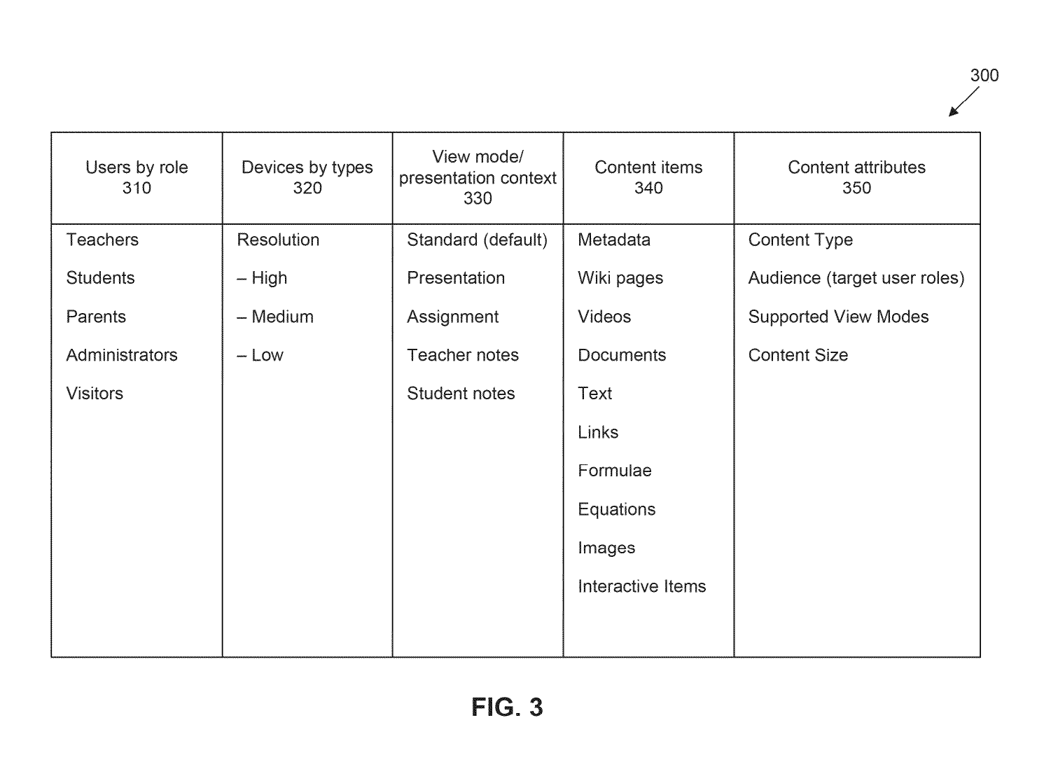

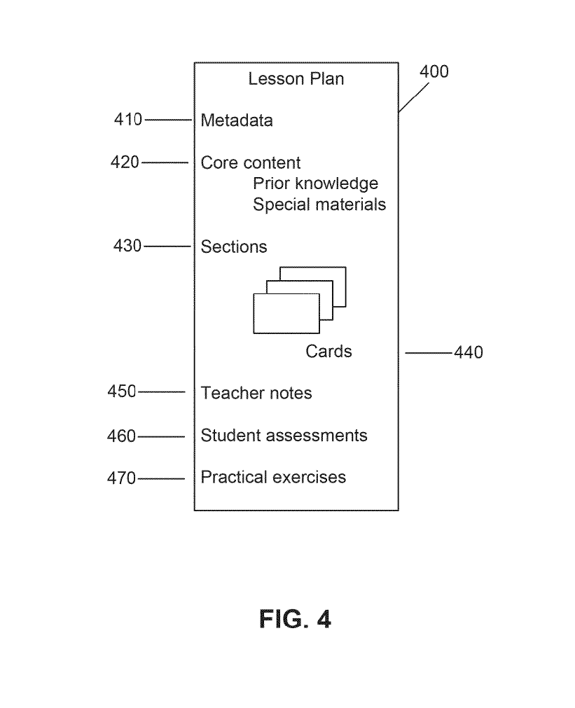

FIG. 2 is a diagram of an example method 200 for contextual page generation, according to an embodiment (stages 202-222). FIG. 3 is a table illustrating examples of user roles, device types, view modes/presentation contexts, content items, and content attributes, according to an embodiment. FIG. 4 is a diagram illustrating example content of an educational lesson plan, according to an embodiment. For brevity, the operation of method 200 is described with respect to system 100, examples depicted in FIG. 3, and the example lesson plan of FIG. 4, which is not intended to be limiting.

As shown in FIG. 2, at stage 202, a user may use a browser 106 at computing device 110 to navigate to a website. In one example, browser 106 may access a URL of a website. The website for example may support a web service hosted by web server 120 and server 130. At stage 204, web server 120 may serve an initial page provided by server 130 to the browser 106 that allows a user to select a view mode/presentation context. Alternatively, a default view mode may be used until a user selects otherwise. The view mode may vary depending upon a particular web service or content being provided. In an embodiment, a view mode/presentation context may be selected automatically by contextual page constructor 132 based on attributes of a user request, such as but not limited to, the role of the user submitting the request, the type of content being requested, and the type and resolution of the requesting device.

In one example, a web service of system 100 and method 200 may support education and instruction. In one example implementation shown in table 300, users may have one or more different roles 310, such as, a teacher, student, parent, administrator or visitor. Computing devices 110 may have different resolution types 320 including, high, medium, or low display resolution. In various embodiments, display resolutions may be categorized differently for purposes of selecting content items for display. Multiple view modes/presentation contexts 330 are provided for educational lesson plans, which may include one or more of standard (default), presentation, assignment, teacher notes, and student notes. For example, the presentation view mode may hide content such as teacher notes, while the teacher notes view mode may include additional notes and information beyond the core content of the lesson plan. Further, the display resolution 320 of a computing device may cause contextual page constructor 132 to optimize displayed content for the computing device. For example, a teacher browsing through multiple lesson plans on a mobile phone may initially see only certain distinctive content or elements of the lesson plan by default, while a teacher browsing lesson plans on a desktop computer may initially see all content associated with a lesson plan.

Content items 340 may include one or more resources such as, but not limited to, metadata, wiki pages, videos, documents, text, links, formulae, equations, images, and interactive items. In the example above, metadata may refer to data describing a lesson plan, such as but not limited to, title, description, or length of lesson. In an embodiment, interactive items may be stored in content database 150 or provided by a third-party service, such as 3^{rd} party 162. In the example above, interactive items may be embedded in a lesson plan and controlled and/or formatted for display via an application programming interface (API) provided by a third-party. Example interactive items may include student assessments, interactive polls, or interactive graphing calculators.

Content attributes 350 may include type of content, audience (targeted users or user roles), supported view modes, and content size. In an embodiment, each content item 340 includes one or more content attributes 350. Type of content may refer to a content item's type, such as video, document, or interactive item. Supported view mode may refer to view modes/presentation contexts 330 for which a content item should be displayed. For example, text used for teacher notes may indicate the teacher notes view mode as supported, but not the presentation or student notes view modes. Content size may refer to a measured size of the content item, such as in pixels, or the device resolutions for which the content item may be displayed.

FIG. 4 shows an example lesson plan 400. Lesson plan 400 may include metadata 410, core content 420, such as, prior knowledge and special materials, and sections 430. Each section 430 may further include cards 440, teacher notes 450, student assessments 460, and practical exercises 470. Cards 440 may serve as containers of content items, such as content items 340, for the lesson plan. For example, cards 440 may include embedded video, text, audio, images and/or other types of content. Lesson plan 400 may be structured content 140 stored in content database 150. Teacher notes 450, student assessments 460, and practical exercises 470 may similarly include one or more content items. In an embodiment, each section of lesson plan 400 may include references to content items stored in content database 150. These references may also be stored in content database 150, for example within an association table or as object lists in a document- or object-oriented database. In this manner, content items may be shared and referenced by multiple lesson plans. An example lesson plan, including components 410-470, is further described in U.S. Provisional Application No. 62/031,663 and U.S. Provisional Application No. 62/093,877, which are incorporated herein by reference in their entirety.

At stage 206, device 110 may send a request for structured content including the selected view mode/presentation context, a user role of the user, and a structured content identifier. In an embodiment, the request may be sent to server 130 for processing by contextual page constructor 132. In another embodiment, the request may be sent to web server 120, which may then forward the request to server 130 for processing by contextual page constructor 132. In various embodiments, the presentation context may be determined by contextual page generator 132 through data received in the request, rather than by a user selection. For example, contextual page generator 132 may use the uniform resource locator (URL) of the submitting web page to determine which view mode/presentation context the user should see. Contextual page constructor 132 may then perform stages 212-218.

At stage 212, contextual page constructor 132 may receive the request for structured content, and at stage 214 may retrieve content items associated with the structured content identifier from database 150 to fulfill the received content request. For example, such retrieved content items may be a part of lesson plan 400 or other structured content 140.

At stage 216, contextual page constructor 132 may select one or more content items from the retrieved content items based at least on the user role and selected or determined presentation context associated with the content request. For example, consider the case of a lesson plan 400. If the user has a role of teacher and a presentation mode has been selected, content items from the retrieved content items may be selected that are relevant to presenting lesson plan 400 to one or more students. In one example, contextual page constructor 132 may review the lesson plan 400 and extract content items marked for the particular view mode (presentation context) and for the teacher role. In an embodiment, targeted view modes and user roles for each content item may be found in corresponding content attributes. Other content attributes, such as content type and content size, may be also be used by contextual page constructor 132 when selecting appropriate content items for each presentation context/user role combination.

At stage 218, a page (or series of pages) may be generated from the selected content items corresponding to a presentation view mode and the user role of teacher. In an embodiment, the retrieved content items may make up the various components and sections of lesson plan 400, and the selected content items may be chosen specifically for a particular presentation context/user role combination. A presentation mode and teacher role, for example, may cause contextual page constructor 132 to hide meta data 410, core content 420, teacher notes 450, and student assessments 460, but show one or more cards 440 with embedded video, text, slides, or images that correspond to content items to be presented to students in a lesson presentation. A card, for example, may include a launch video with a colorful illustration intended to build student interest. The presentation mode for a teacher role may also include discussion questions, for example in practical exercises 470, to encourage discussion among students during presentation of the lesson plan. Similarly, if a user role or presentation context in a content request is different, then different content may be extracted from lesson plan 400 accordingly. For example, in the case of a standard mode and a teacher role, all portions of lesson plan 400 and included content items may be extracted for inclusion on one or more pages. On the other hand, in the case of a standard mode and a student role, portions of lesson plan 400 pertinent to a student and included content items may be extracted for inclusion on one or more pages.

At stage 220, the constructed page may be sent to computing device 110 that requested the content. At stage 222, Device 110 may then receive the constructed page and, at stage 224, may render the received constructed page for display. Such rendering may also be used with a responsive display device.

In this way, method 200 allows a user to view a page constructed according to a selected or determined view mode/presentation context and user role. The page is constructed from structured content that includes a plurality of content items, which facilitates processing and extraction of content according to a presentation context and user role. This example is not limited to presentation context and user role, and other criteria may be used, such as device display resolution, as discussed previously.

### Structured Content Creation

FIG. 5 is a flowchart illustrating an example method 500 for structured content creation, according to an embodiment. At stage 502, a user may select a content type to author. For example, a user that is a teacher may select a lesson plan 400 to create.

At stage 504, an initial template corresponding to the content type may be provided to the user. At stage 506, user input into the template may be received instructing to add, edit, or delete content, such as content items 340 of FIG. 3, according to the initial template. Content may be chosen from existing content stored in a content database (e.g., structured content database 150 of FIG. 1), such as existing videos or interactive items, or a user may create new content items. When new content items are created, according to an embodiment, a user may specify various content attributes associated with the content item, such as type of content, audience, and supported view modes, as described with respect to FIG. 3. These attributes may also be derived automatically after submission based on the actual content received.

At stage 508, structured content may then be generated according to the received user input into the template. At stage 510, the structured content, including created content items, may then be stored in structured content database 150. In one embodiment, content creation may be carried out by another server (not shown) to generate structured content 140 for storage in structured content database 150.

In an embodiment, structured content, such as a lesson plan, may include comments and/or annotations stored in structured content database 150. For example, after a lesson plan is created, the same or a different user may seek to edit the lesson plan. A user may add comments or annotations to the lesson plan in order to facilitate collaboration and discussion among multiple authoring users. This collaboration can improve a lesson plan through input of multiple users.

### Quick Code Management

FIG. 6 is a flowchart illustrating an example method 600 for creating and managing quick codes associated with structured content, according to an embodiment. Quick codes allow users to view structured content or a determined subset of structured content by referencing a generated code. In an embodiment, each quick code is linked to particular structured content, such as a lesson plan, and structured content may be associated with multiple quick codes. Quick codes may be used by teachers, for example, to create student assignments based on a particular lesson plan.

Method 600 begins at stage 602 by receiving a request from a user computing device to create a quick code for particular structured content, such as an educational lesson plan. In an embodiment, the particular structured content is identified by a structured content identifier. In an embodiment, the request may be received by a quick code manager for processing, such as quick code manager 134 or FIG. 1. The quick code manager may additionally perform or initiate stages 604-608, described in further detail below.

At stage 604, a new quick code may be generated. In an embodiment, generated quick codes may be stored in a content database, such as structured content database 150 of FIG. 1. In various embodiments, quick codes may be globally unique within the content database, or unique within a group that the requesting user is a member of. For example, quick codes may be unique within a particular enterprise environment, such as among users within a public school district. The generated quick code may be associated with and owned by the requesting user. A generated quick code may be changed by the owner as long as the updated code does not violate an implemented uniqueness constraint.

At stage 606, a subset of the structured content may be created and associated with the generated quick code may be determined. The subset of content associated with the quick code from the original structured content may be selected by the requesting user and/or determined by the quick code manager. For example, a teacher may use quick codes to create a student assignment for a particular lesson plan. The teacher may specify which resources should be included in the assignment by, for example, selecting particular content items or sections to include. In the example of a student assignment, the teacher may include video review portions and interactive items such as student assessments. The teacher may also specify default and supportable view modes (e.g., student view modes), as well as authorized user roles. The quick code manager may then choose appropriate content based on at least the specified view modes and user roles. In an embodiment, the subset of content associated with the quick code may be changed after creation of the quick code.

In an embodiment, the subset of structured content associated with the quick code may be managed separately from the original structured content and may be modified without affecting the original structured content. For example, in the case of a lesson plan, the subset of the lesson plan associated with the quick code may point to the same resources as the original lesson plan, but any modifications may be stored separately. This allows, for example, a teacher to customize assignments based on a lesson plan by modifying or adding additional content. Likewise, an owner of a quick code may also control whether changes to the original structured content should effect changes to the content associated with the quick code.

At stage 608, the generated quick code may be linked to the original structured content, for example a particular lesson plan associated with the quick code request. In an embodiment, this may be accomplished by linking the generated quick code to the structured content identifier, for example using a database foreign key. This may enable a user to efficiently manage multiple quick codes linked to the original structured content. For example, a teacher may create student assignments of varying degrees for a particular lesson plan. Each student assignment may be associated with a different quick code, but each quick code is linked to the original lesson plan.

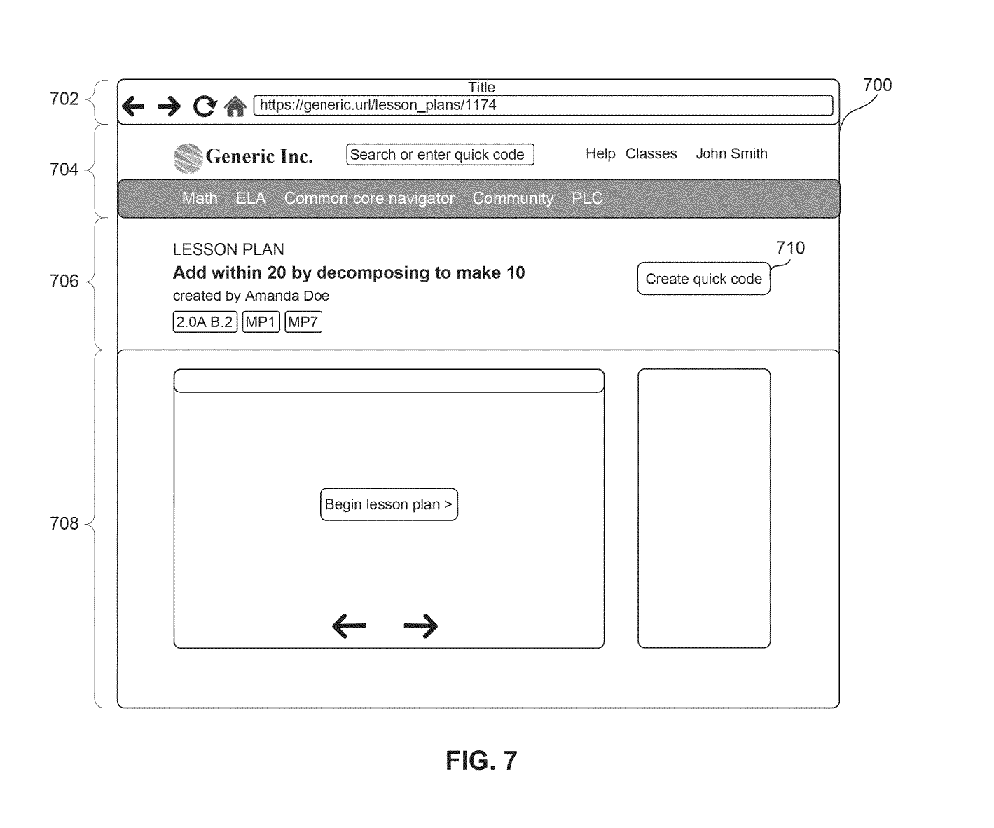

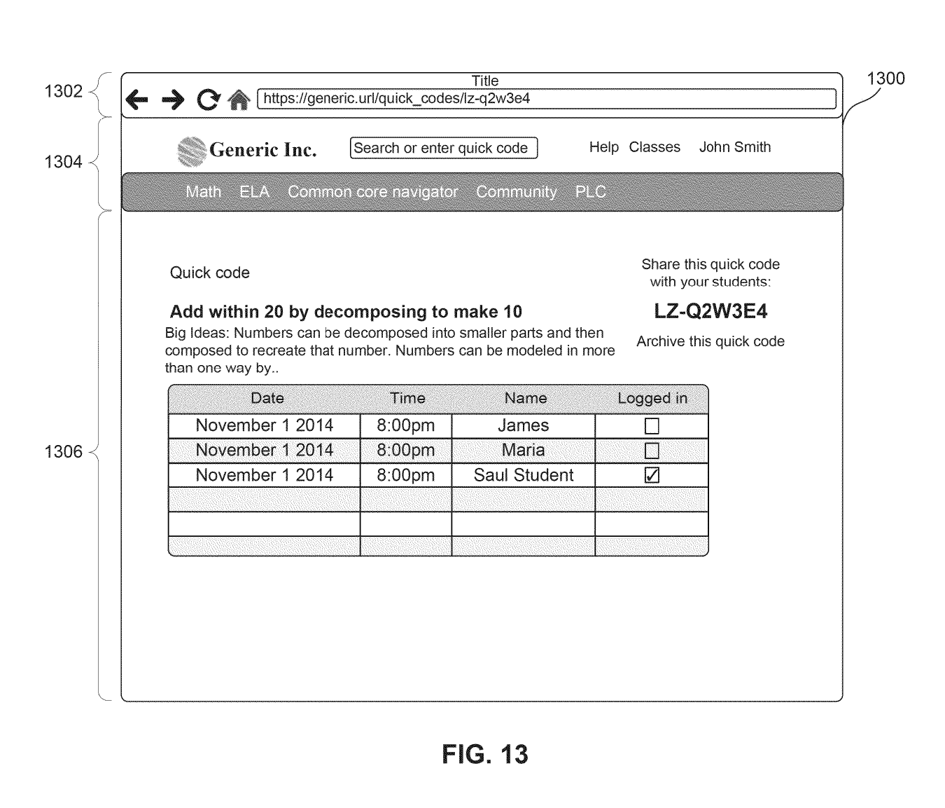

Quick codes may also be managed at a per user level, allowing a user to view all created and/or owned quick codes. In an embodiment, access using a quick code may initiate a user session, which may be recorded. The owner of the quick code may then view a list of recorded sessions. For example, student assignments accessed by students may be recorded and a list of sessions displayed, as shown in FIG. 13. Further, in an embodiment, user input to interactive items may be recorded for each user session. This may be useful, for example, for a teacher to view a particular student's answers to an assigned quiz. Quick codes are further described in FIGS. 7-14 in the context of educational lesson plans for purposes of example and not limitation.

FIG. 7 is an example interface 700 for initiating a request to create a quick code, according to an embodiment. Interface 700 displays and example lesson plan accessed via a web browser on a user computing device, such as computing devices 110 of FIG. 1. Interface 700 includes panels 702, 704, 706, and 708. In an embodiment, panel 702 may provide browser navigation functionality of a web browser, panel 704 may provide website navigation functionality, panel 706 may display general information for an educational lesson plan, and panel 706 may display lesson plan content. In an embodiment, button 710 may enable a user to submit a request to create a quick code associated with the displayed lesson plan, which is described further with respect to FIG. 6.

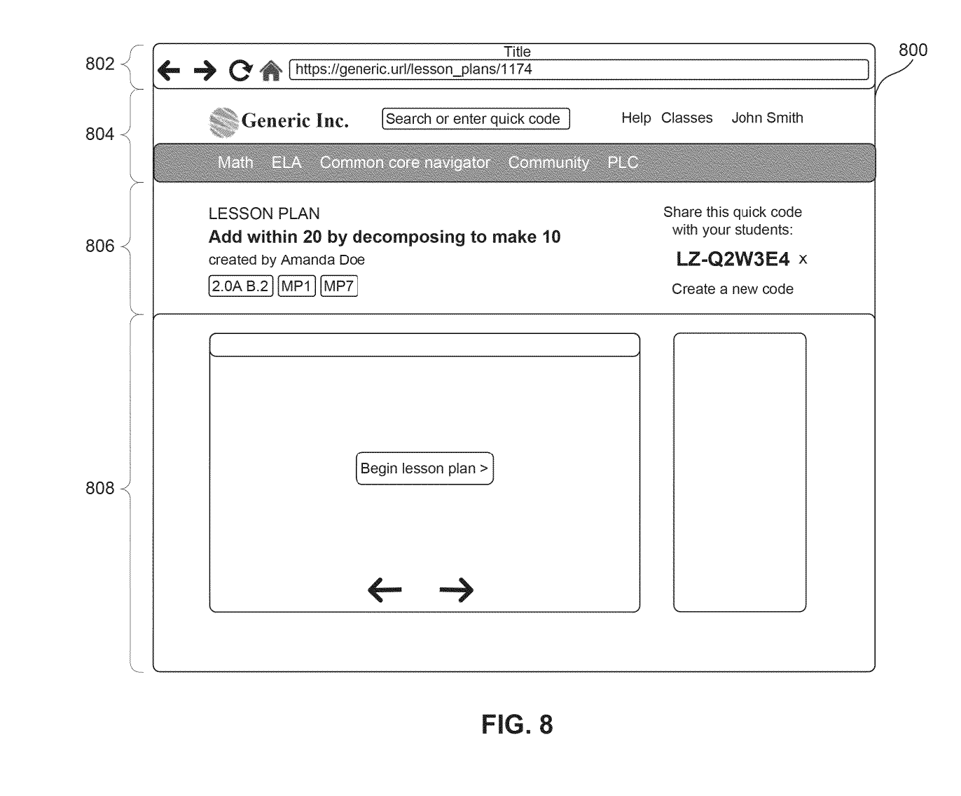

FIG. 8 is an example interface 800 displaying a quick code for a lesson plan after a quick code is created, according to an embodiment. Interface 800 includes a browser navigation panel 802, a website navigation panel 804, a lesson plan information panel 806, and a lesson plan content panel 808. Panel 806 further displays a generated quick code associated with the displayed lesson plan.

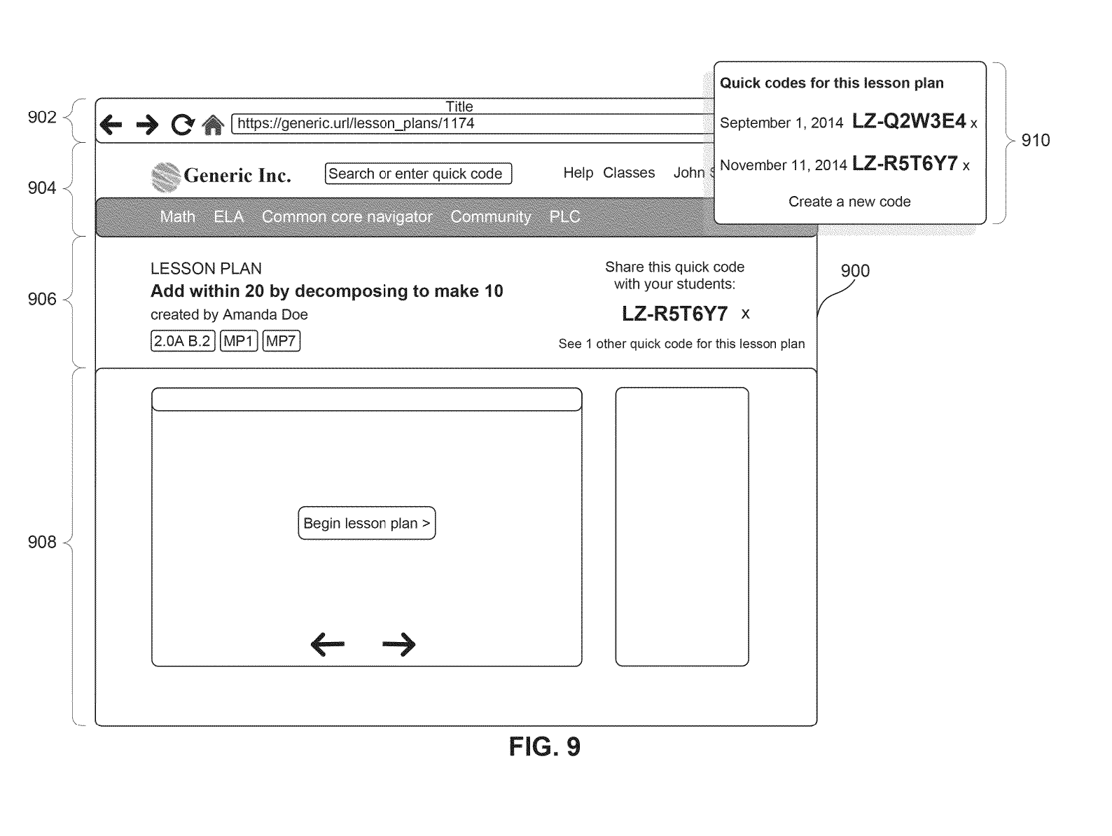

FIG. 9 is an example interface for managing quick codes for assignments associated with a lesson plan, according to an embodiment. Interface 900 includes a browser navigation panel 902, a website navigation panel 904, a lesson plan information panel 906, a lesson plan content panel 908, and a management panel 910. Management panel 910 enables a user to view created and/or owned quick codes associated with the lesson plan displayed in panels 906 and 908.

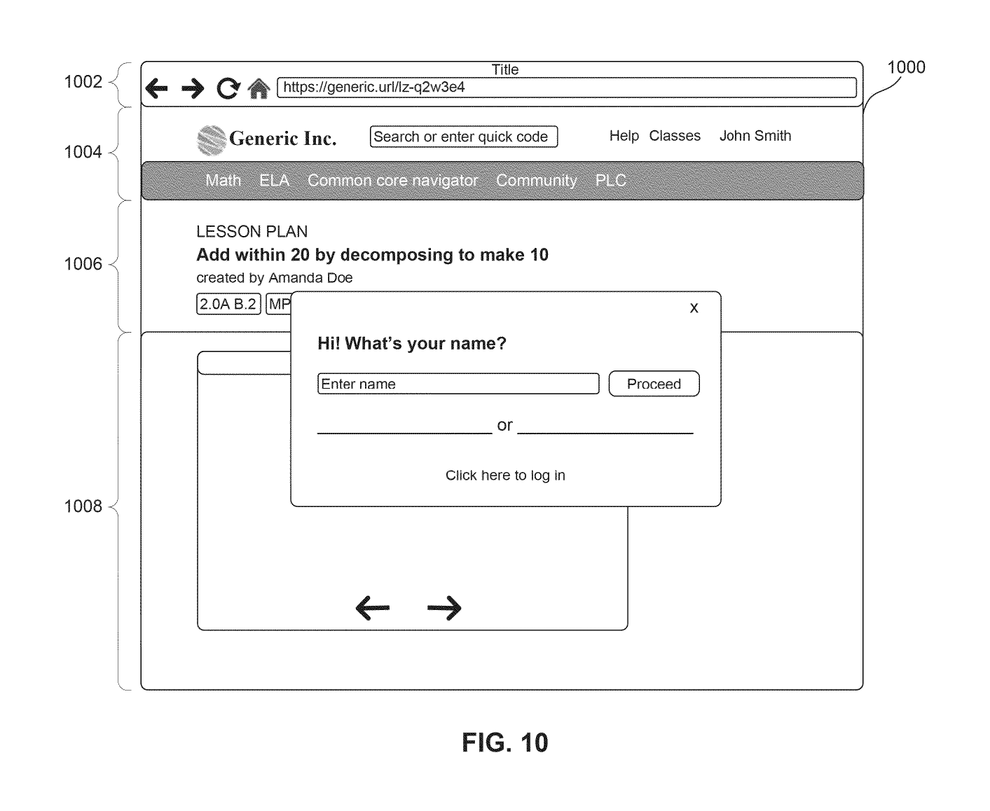

FIG. 10 is an example interface displaying a lesson plan accessed by an unauthenticated user using a quick code, according to an embodiment. Interface 1000 includes a browser navigation panel 1002, a website navigation panel 1004, a lesson plan information panel 1006, a lesson plan content panel 1008, and a login panel 1010. In an embodiment, structured content associated with a quick code may be accessed by guest users without requiring authentication. This may be an option selected by a creator or owner of a quick code. In this case, panel 1010 enables the name of the accessing user to be recorded.

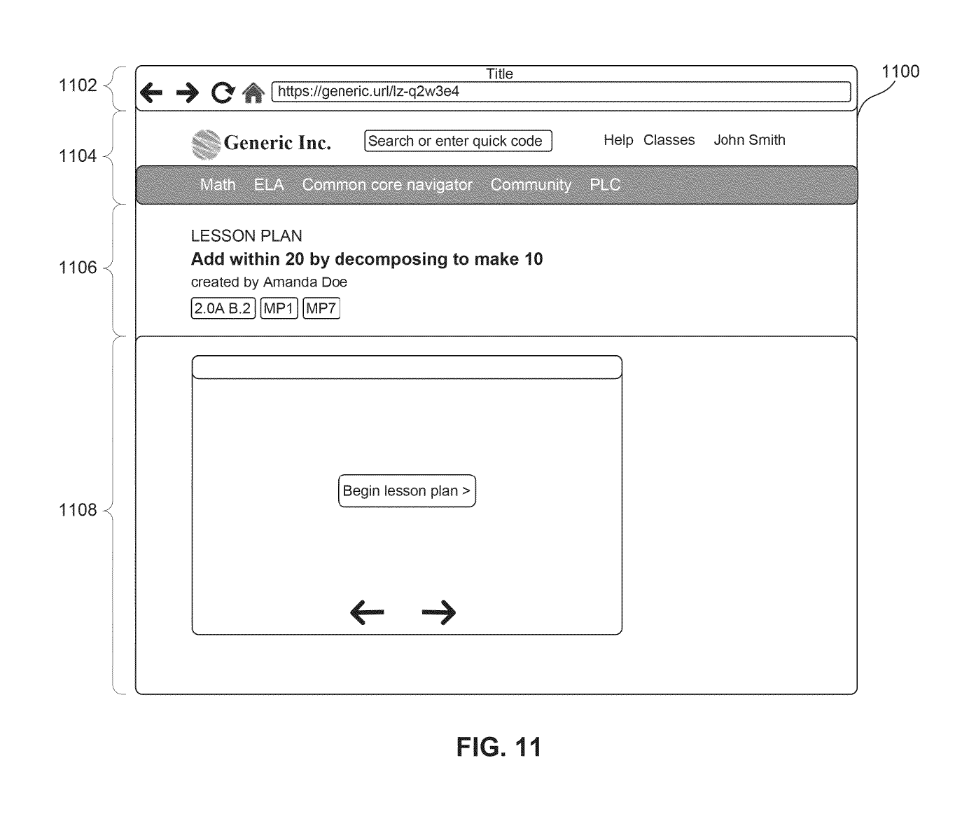

FIG. 11 is an example interface displaying a lesson plan accessed using an assigned quick code, according to an embodiment. Interface 1100 includes a browser navigation panel 1102, a website navigation panel 1104, a lesson plan information panel 1106, a lesson plan content panel 1008, and a login panel 1110. In an embodiment, users may access a lesson plan associated with a quick code in a web browser through a unified resource locator (URL), as shown in panel 1102. An unauthenticated user attempting to use a quick code may first be asked for their name, as described with respect to FIG. 10. Authenticated users attempting to use a quick code may have their name automatically populated from existing account information, according to an embodiment, as shown in panel 1104.

The quick codes and lesson plans depicted in FIGS. 10 and 11 may be useful, for example, within a classroom setting. For example, a classroom may have a small number of laptops for student use. In this case, one or more students may access the lesson plan on one of the laptops in class while working on an assignment. This allows a student to review concepts of the lesson while in class, but the student may only have access to student-specific content of the lesson plan as configured by the quick code. In another example, a classroom may have laptops or tablets for each student. The teacher may create a quick code to use for presentation, allowing students to follow along on their individual computing devices.

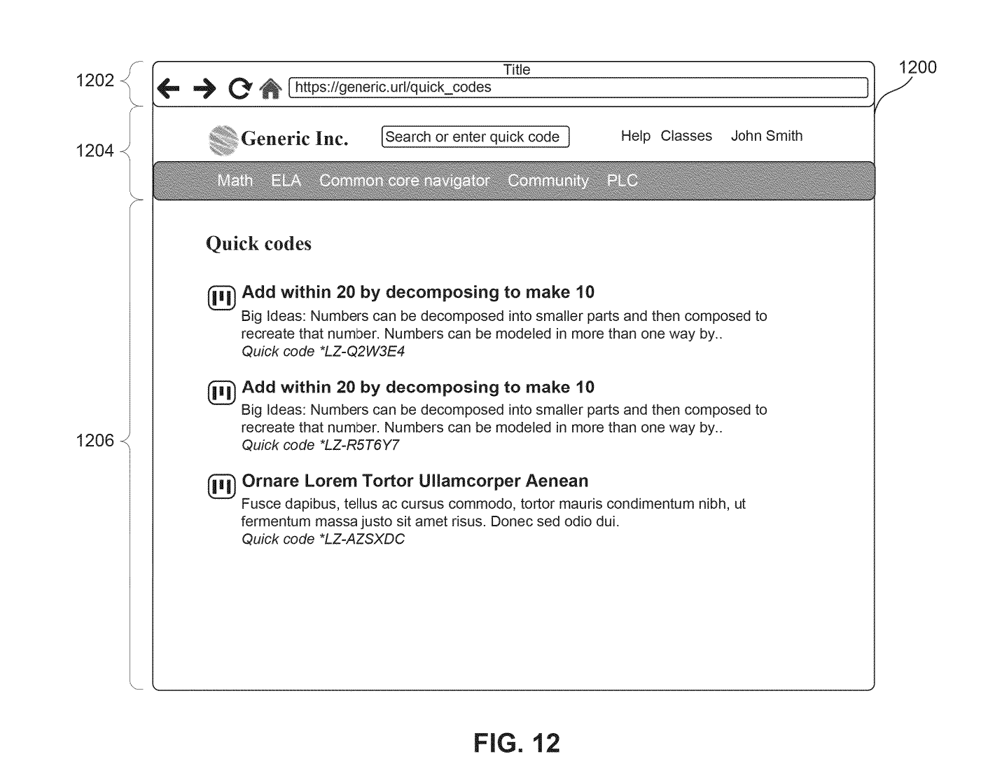

FIG. 12 is an example interface for viewing assignment sessions associated with a particular user, according to an embodiment. Interface 1200 includes a browser navigation panel 1202, a website navigation panel 1204, and a quick code management panel 1206. In an embodiment, panel 1206 may display all quick codes created and/or owned by a particular user. For example, this enables a teacher to efficiently view and manage all created quick codes in one place. In an embodiment, the displayed quick codes may also be filtered by one or more criterion, such as by lesson plan.

FIG. 13 is an example interface for viewing assignment sessions associated with a particular assigned quick code, according to an embodiment. Interface 1200 includes a browser navigation panel 1202, a website navigation panel 1204, and a session management panel 1206. As described with respect to FIG. 6, when a user accesses a lesson plan using a quick code, a session is created that is associated with that particular quick code and lesson plan. Creators and owners of quick codes may be able to view both current sessions and historical sessions associated with a particular lesson plan or quick code. This enables, for example, a teacher to track access to created student assignments based on a particular lesson plan. For example, a teacher may assign homework through use of a quick code. In this example, the subset of content associated with the quick code may include an interactive quiz. The use of quick codes may allow teachers to view each student's answers to the quiz by recording the answers in separate user sessions associated with the quick code. The teacher may then grade the quiz answers, and a student may be able to view grades by subsequent access to the same quick code.

FIG. 14 is a diagram illustrating an example schema to represent quick code functionality in an educational environment, according to an embodiment. In an embodiment, quick codes may be owned by a teacher or administrator of a lesson plan. As described previously, each quick code may be linked to a particular lesson plan, and the owner of a quick code may customize a subset of lesson plan content to be associated with the quick code. One of skill in the art will appreciate that the example schema shown in FIG. 14 is for purposes of example, and other schemas within or outside of an educational environment may be used to represent the previously described quick code features.

### Example Constructed Page

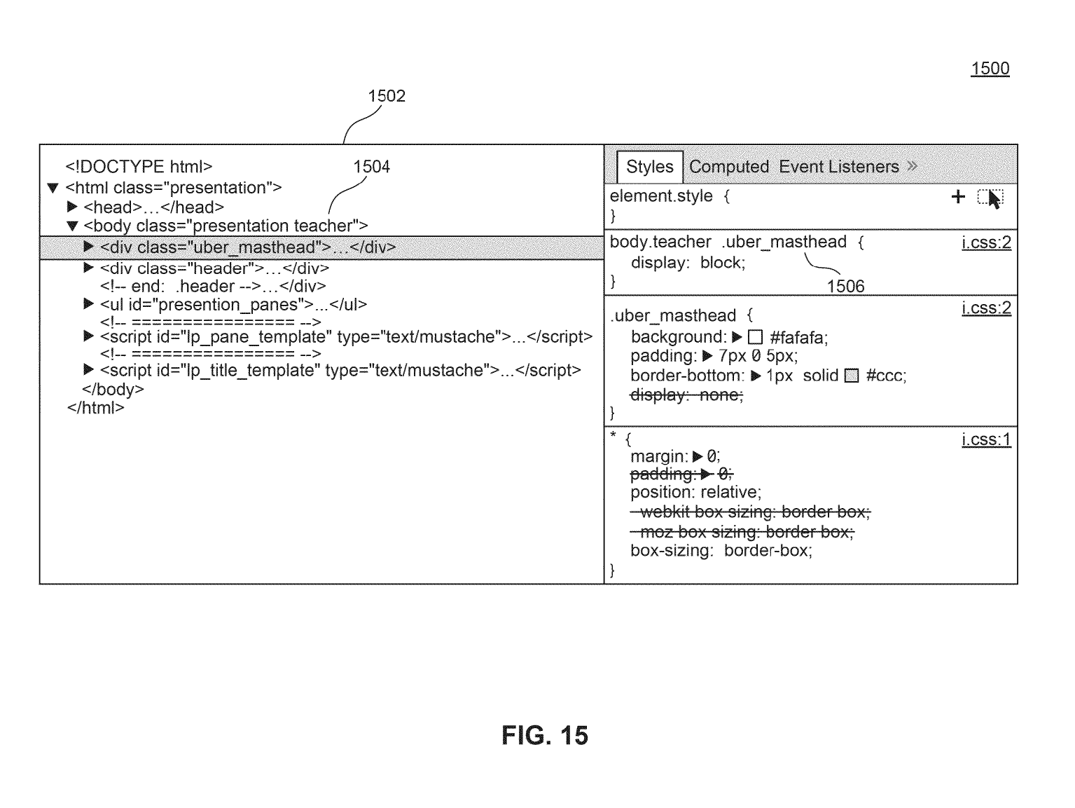

FIG. 15 illustrates example markup for a contextual page representing a lesson plan generated for a teacher using a presentation view mode, according to an embodiment. This markup may be interpreted by a web browser, for example, to display the appropriate content of a lesson plan to a user. In this example, the presentation view mode displays one or more elements of the lesson, but does not display associated teacher notes. Additionally, the presentation view mode allows a teacher to request other teacher-specific view modes, such as a teacher notes view mode/presentation context. A person of skill in the art will appreciate that the different view modes may present different content to the user without the need to author multiple versions of the lesson plan.

In FIG. 15, the view mode “presentation” and the user role “teacher” are specified within panel 1502 as values of the class attribute of the body tag, as shown at 1504. The view mode and user role seen here dictate content that is presented to the user. For example, different teacher-specific view modes that may be selected are presented to the user, as can be seen in the markup at 1506:
body.teacher.uber_masthead {display: block;}

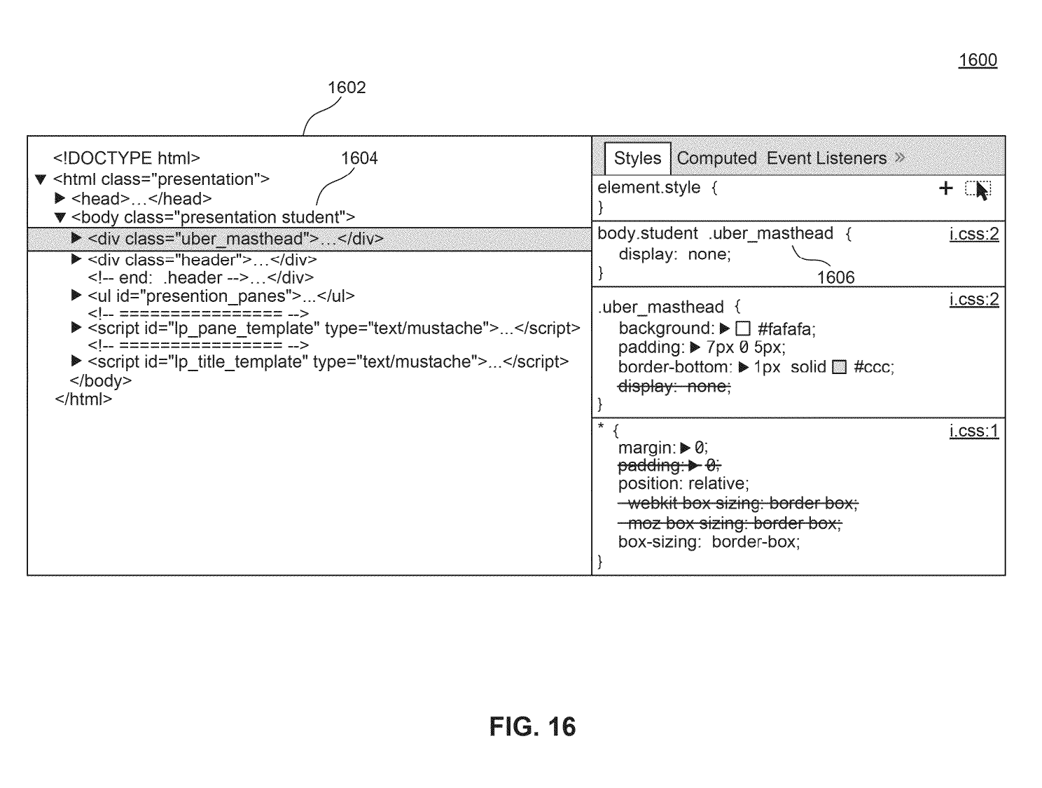

FIG. 16 illustrates example markup for a contextual page representing a lesson plan generated for a student using the presentation view mode, according to an embodiment. FIG. 16 presents similar content to that of FIG. 15, as shown at 1604 within panel 1602; however, in this example, the student is unable to request teacher-specific view modes. In this way, different content may also be presented to the user based on user roles without the need to author multiple versions of a lesson plan.

In FIG. 16, the view mode “presentation” and the user role “student” are specified as values of the class attribute of the body tag. In this example, the different teacher-specific view modes that may be selected are not presented to the user, as can be seen in the markup at 1606:
body.student.uber_masthead {display: none;}

### Further Examples and Advantages

Contextual page generation from structured content in accordance with embodiments of system 100, methods 200 and 500, quick code creation 600, and/or user-interfaces as described above with respect to FIGS. 1-16 (also called for example a platform) can provide a number of advantages and features as evident in the following examples. This is particularly advantageous for lesson plan development and creation because it allows great instructional content to be provided which serves multiple purposes across different contexts and for individuals who occupy different roles.

For example, take the case of a lesson focused on the decomposition of fractions into other fractions. With the contextual page generation from structured content described herein effective lesson plans to decompose fractions can be readily developed by groups of teachers, and further honed and tailored by individual teachers in preparation for class presentation. Further advantages are the flexibility obtained which allows a lesson plan to be presented and controlled from different types of devices that a teacher may use and displayed to small groups of students or one-on-one with a student while automatically accounting for the same or different types of devices the students may use. Follow on homework and parent guidance can occur based on the lesson plan. As the teacher gains experience, a teacher can add more information or switch to a mode that highlights new or even more detailed information.

Consider the following contexts for a lesson plan creation and development over time according to an embodiment here:

Context 1: A group of teachers works together over the summer to create or improve a lesson.

In this context, a group of teachers has been convened by a school district to revise the assessment, add examples, and in general make the lesson better. The teachers are therefore designated authors and are given permission to switch the lesson into “edit” mode. In response, system 100 can reveal to them a comment stream from original authors, who had previously engaged in a long discussion about why the fraction % is a good choice for the introductory exercise. In this way the act of developing or further working on a lesson is powerful professional development for the teachers involved, and in this case being able to read and contribute to the comment stream allows this year's authors to build upon the pedagogical content knowledge of their predecessors while adding to their own. In turn, their discussions, organically captured by system 100 will be revealed to any future generations of contributors in similar contexts.

Context 2: A first-year 4th grade teacher is spending Sunday night swiping through possible lesson choices for tomorrow's math class on her phone.

In this case, system 100 presents a view of the lesson that is optimized for the small screen, focusing on the most important and distinctive elements of the lesson (the title, the main slides, etc.). However, since this is a teacher, she still has access—even on her phone—to other critical features, such as the worksheets, and the teacher's notes for the classroom activity.

Context 3a: The teacher is presenting the material to her class on Monday.

System 100 can allow the teacher to project the whole-class oriented material at scale. In particular, there may be a launch video that builds student interest with an illustration of the concept based on pouring colored sand into a container.

Context 3b: The teacher controls the presentation from her tablet.

While projecting the material to her class, the teacher simultaneously has access to discussion questions that help her ensure that the ensuing conversation among students is a rich one.

Context 4: Small groups of students work on a project in class.

After the whole-class presentation, groups of students work on creating and measuring their own designs with bands of colored sand. The teacher has only a few laptops in class for their use, but whenever a group needs to review a concept from the video or re-read the directions for the activity, they can bring one over to their table. In this case, the same URL for the lesson shows a full student view—they can page back and forth through all of the materials and see all of the student-facing, but not teacher-facing materials.

Context 5: A one-to-one alternative.

In a different 4th grade classroom, the school has invested in a full one-to-one setup, meaning that every student has a GOOGLE CHROMEBOOK device or other computer, tablet, laptop or mobile device at their desk (e.g., one device to one student). In this case, the teacher presents the material to each student's screen using a quick code; the students see one screen's worth of material at a time, while the teacher controls the experience from his APPLE IPAD or other computer, tablet, laptop or mobile device.

Context 6a-c: Homework.

Both of the teachers described above with respect to contexts 2-5 can use quick codes to assign homework from the lesson. (a) Using the quick code, the students are taken to a view of the lesson that enables them to complete the interactive quiz items. (b) The teachers, using the same codes, have a view that allows them to see answers, and to grade the submissions. (c) Following grading, the original code takes students to a view of the lesson in which they can see their answers compared to the answer key. System 100 knows that unauthenticated users are probably students and lets them complete the assignment first before the teacher links up the data later.

Context 7: Parent guidance

Parents of the 4th graders in these classes can use system 100 as well—not only to have full access to all that a student sees, but also to guidance on how to best support their children at home.

Context 8: Teacher preparation

The following year, the original teacher described with respect to contexts 2-4 has a bit more experience under her belt. When it comes times to teach the topic again, she is ready to dig a bit deeper or add new information. She notices for the first time the lesson includes additional information or decides to add new information herself, and can switch to a mode that highlights this new or deeper information.

These examples and advantages are illustrative and not intended to necessarily limit embodiments of the present invention.

### Example Computing Device

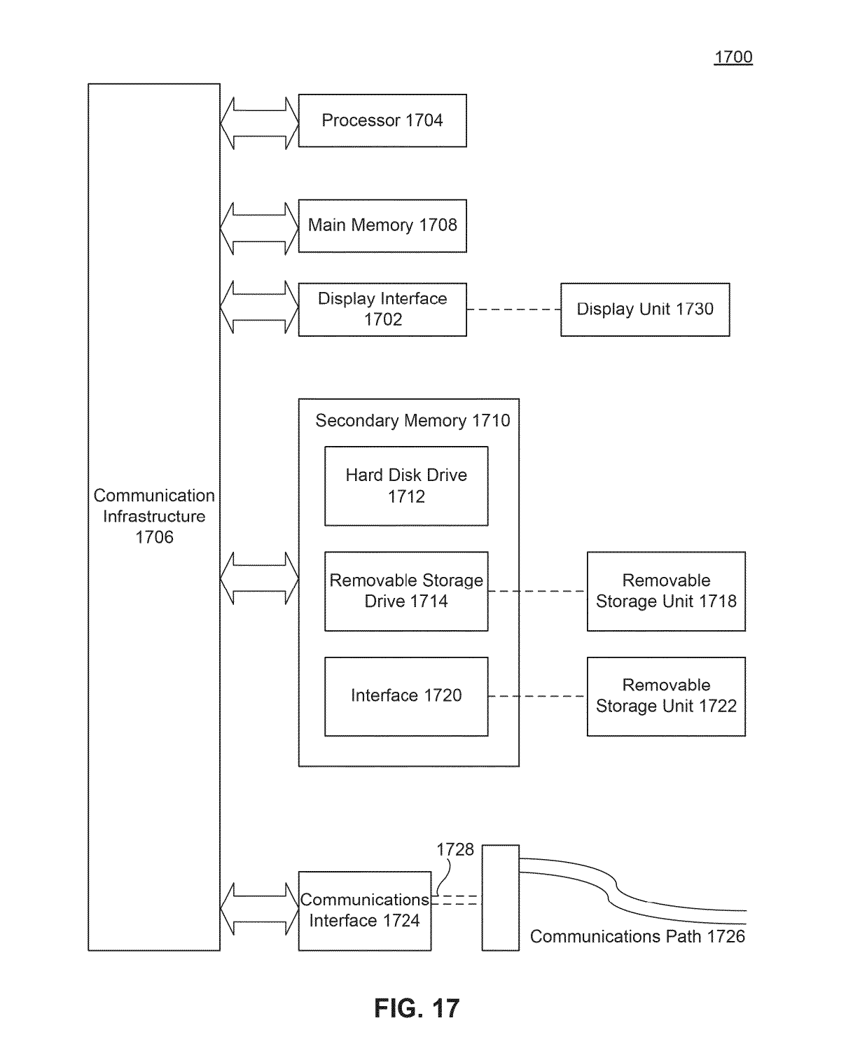

FIG. 17 is an example computing system useful for implementing various embodiments. Various embodiments can be implemented, for example, using one or more well-known computer systems, such as computer system 1700. Computer system 1700 can be any well-known computer capable of performing the functions described herein, such as computers available from International Business Machines, Apple, Sun, HP, Dell, Sony, Toshiba, etc.

Computer system 1700 includes one or more processors (also called central processing units, or CPUs), such as a processor 1704. Processor 1704 may be connected to a communication infrastructure or bus 1706.

One or more processors 1704 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 1700 also includes user input/output device(s) 1703, such as monitors, keyboards, pointing devices, etc., which communicate with communication infrastructure 1706 through user input/output interface(s) 1702.

Computer system 1700 also includes a main or primary memory 1708, such as random access memory (RAM). Main memory 1708 may include one or more levels of cache. Main memory 1708 has stored therein control logic (i.e., computer software) and/or data.

Computer system 1700 may also include one or more secondary storage devices or memory 1710. Secondary memory 1710 may include, for example, a hard disk drive 1712 and/or a removable storage device or drive 1714. Removable storage drive 1714 may be a floppy disk drive, a magnetic tape drive, a compact disk drive, an optical storage device, tape backup device, and/or any other storage device/drive.

Removable storage drive 1714 may interact with a removable storage unit 1718. Removable storage unit 1718 includes a computer usable or readable storage device having stored thereon computer software (control logic) and/or data. Removable storage unit 1718 may be a floppy disk, magnetic tape, compact disk, DVD, optical storage disk, and/or any other computer data storage device. Removable storage drive 1714 reads from and/or writes to removable storage unit 1718 in a well-known manner.

According to an exemplary embodiment, secondary memory 1710 may include other means, instrumentalities or other approaches for allowing computer programs and/or other instructions and/or data to be accessed by computer system 1700. Such means, instrumentalities or other approaches may include, for example, a removable storage unit 1722 and an interface 1720. Examples of the removable storage unit 1722 and the interface 1720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1700 may further include a communication or network interface 1724. Communication interface 1724 enables computer system 1700 to communicate and interact with any combination of remote devices, remote networks, remote entities, etc. (individually and collectively referenced by reference number 1728). For example, communication interface 1724 may allow computer system 1700 to communicate with remote devices 1728 over communications path 1726, which may be wired and/or wireless, and which may include any combination of LANs, WANs, the Internet, etc. Control logic and/or data may be transmitted to and from computer system 1700 via communication path 1726.

In an embodiment, a tangible apparatus or article of manufacture comprising a tangible computer useable or readable medium having control logic (software) stored thereon is also referred to herein as a computer program product or program storage device. This includes, but is not limited to, computer system 1700, main memory 1708, secondary memory 1710, and removable storage units 1718 and 1722, as well as tangible articles of manufacture embodying any combination of the foregoing. Such control logic, when executed by one or more data processing devices (such as computer system 1700), causes such data processing devices to operate as described herein.

Based on the teachings contained in this disclosure, it will be apparent to persons skilled in the relevant art(s) how to make and use the inventions using data processing devices, computer systems and/or computer architectures other than that shown in FIG. 17. In particular, embodiments may operate with software, hardware, and/or operating system implementations other than those described herein.

### CONCLUSION

Identifiers, such as “(a),” “(b),” “(i),” “(ii),” etc., are sometimes used for different elements or stages. These identifiers are used for clarity and do not necessarily designate an order for the elements or stages.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described embodiments, but should be defined only in accordance with the following claims and their equivalents.

What is claimed is:

1. A system for contextual page generation, comprising:
one or more computing devices;
a content database storing structured content;
a contextual page constructor, implemented on the one or more computing devices, configured to:
receive a request from a user computing device for structured content, the request including a user role, a presentation context, and a structured content identifier;
retrieve content items associated with the structured content identifier from the content database;
select one or more content items from the retrieved content items based on at least the user role and the presentation context;
construct a page including the selected content items; and
transmit the constructed page to the user computing device for rendering and display on the computing device.

2. The system of claim 1, wherein the request includes a device resolution, and wherein the contextual page constructor is further configured to select the one or more content items based at least on the device resolution.

3. The system of claim 1, wherein each content item is associated with one or more content attributes, and wherein contextual page constructor is further configured to select the one or more content items by:
comparing content attributes of each retrieved content item to the user role and the presentation context to determine whether to select the content item.

4. The system of claim 3, wherein the one or more content attributes comprise at least one of content type, audience, supported view modes, and content size.

5. The system of claim 1, wherein the structured content comprises a lesson plan, and wherein the retrieved content items comprise at least one of metadata associated with the lesson plan, wiki pages, videos, documents, text, links, formulae, equations, images, and interactive items.

6. The system of claim 5, wherein the contextual page generator is further configured to retrieve an interactive item via an application programming interface (API) provided by a third-party service.

7. The system of claim 1, wherein the structured content comprises one or more sections, and wherein each section includes one or more of the retrieved content items.

8. The system of claim 7, wherein the structured content sections comprise at least one of cards, teacher notes, student assessments, practical exercises, and additional materials.

9. The system of claim 7, wherein the contextual page constructor is further configured to:
determine one or more sections of the structured content to be presented based on at least the user role and the presentation context; and
select one or more content items associated with the determined sections from the retrieved content items.

10. The system of claim 1, further comprising:
A quick code manager, implemented on the one or more computing devices, configured to:
receive a request to create a new quick code for structured content, the structured content being associated with a particular structured content identifier;
generate a unique quick code;
determine a subset of the structured content to associate with the generated quick code based on the received request; and
link the generated quick code to the structured content identifier.

11. A computer-implemented method for contextual page generation, comprising:
receiving a request from a user computing device for structured content, the request including a user role, a presentation context, and a structured content identifier;
retrieving content items associated with the structured content identifier from a content database;
selecting one or more content items from the retrieved content items based on at least the user role and the presentation context;
constructing a page including the selected content items; and
transmitting the constructed page to the user computing device for rendering and display on the computing device.

12. The method of claim 11, wherein the request includes a device resolution, and wherein the selected content items are selected based at least on the device resolution.

13. The method of claim 11, wherein each content item is associated with one or more content attributes, and wherein the selecting further comprises:
comparing content attributes of each retrieved content item to the user role and the presentation context to determine whether to select the content item.

14. The method of claim 13, wherein the one or more content attributes comprise at least one of content type, audience, supported view modes, and content size.

15. The method of claim 11, wherein the structured content comprises a lesson plan, and wherein the retrieved content items comprise at least one of metadata associated with the lesson plan, wiki pages, videos, documents, text, links, formulae, equations, images, and interactive items.

16. The method of claim 15, wherein interactive items are retrieved via an application programming interface (API) provided by a third-party service.

17. The method of claim 11, wherein the structured content comprises one or more sections, and wherein each section includes one or more of the retrieved content items.

18. The method of claim 17, wherein the structured content sections comprise at least one of cards, teacher notes, student assessments, practical exercises, and additional materials.

19. The method of claim 17, wherein the selecting further comprises:
determining one or more sections of the structured content to be presented based on at least the user role and the presentation context; and
selecting one or more content items associated with the determined sections from the retrieved content items.

20. The method of claim 11, further comprising:
receiving a request to create a new quick code for structured content, the structured content being associated with a particular structured content identifier;
generating a unique quick code;
determining a subset of the structured content to associate with the generated quick code based on the received request; and
linking the generated quick code to the structured content identifier.

21. A non-transitory computer-readable storage device having instructions stored thereon that, when executed by at least one computing device, causes the at least one computing device to perform operations comprising:
receiving a request from a user computing device for structured content, the request including a user role, a presentation context, and a structured content identifier;
retrieving content items associated with the structured content identifier from a content database;
selecting one or more content items from the retrieved content items based on at least the user role and the presentation context;
constructing a page including the selected content items; and
transmitting the constructed page to the user computing device for rendering and display on the computing device.
